(19) United States
(12) Patent Application Publication
(10) Pub. No.: US 2026/0350342 A1
(43) Pub. Date: Nov. 5, 2026

(54) STRUCTURED HIGHER-ORDER MODELING FOR MULTI-MODAL COLLABORATIVE AUTONOMOUS SYSTEMS

(71) Applicant: Raytheon Company, Arlington, VA (US)

(72) Inventor: Kin Gwn Lore, Quincy, MA (US)

(21) Appl. No.: 19/197,849

(22) Filed: May 2, 2025

(51) Int. Cl. G06N 3/006; G06N 3/0455

(52) U.S. Cl. CPC G06N 3/006; G06N 3/0455

(57) ABSTRACT

A method includes receiving data of multiple modalities using at least one transceiver of a node in a multi-modal collaborative autonomous system. The method also includes processing modality-specific embeddings of the received data and generating one or more hypergraphs based on hyperedges constructed using the modality-specific embeddings. In addition, the method includes conducting an analytics process based on the one or more hypergraphs.

### GOVERNMENT RIGHTS

This invention was made with government support under contract number 140D0423C0057 awarded by the Office of the Director of National Intelligence. The government may have certain rights in this invention.

### TECHNICAL FIELD

This disclosure relates generally to collaborative autonomous systems and processes. More specifically, this disclosure relates to structured higher-order modeling for multi-modal collaborative autonomous systems.

### BACKGROUND

Collaborative autonomous systems refer to networks of autonomous agents, such as robots, drones, or software systems, which work together to achieve shared goals. These systems rely on communication, coordination, and decision-making to perform tasks in dynamic environments. Pairwise communication is often used in collaborative autonomous systems, especially decentralized configurations, where two agents are in direct communication to exchange data.

### SUMMARY

This disclosure relates to structured higher-order modeling for multi-modal collaborative autonomous systems.

In some examples, a method includes receiving data of multiple modalities using at least one transceiver of a node in a multi-modal collaborative autonomous system. The method also includes processing modality-specific embeddings of the received data and generating one or more hypergraphs based on hyperedges constructed using the modality-specific embeddings. In addition, the method includes conducting an analytics process based on the one or more hypergraphs.

In other examples, an apparatus includes at least one transceiver and at least one processing device. The at least one processing device is configured to receive data of multiple modalities using the at least one transceiver, where the data is associated with a multi-modal collaborative autonomous system. The at least one processing device is also configured to process modality-specific embeddings of the received data and generate one or more hypergraphs based on hyperedges constructed using the modality-specific embeddings. The at least one processing device is further configured to conduct an analytics process based on the one or more hypergraphs.

In still other examples, a non-transitory machine readable medium includes instruction that when executed cause at least one processor of a node in a multi-modal collaborative autonomous system to receive data of multiple modalities using at least one transceiver of the node. The non-transitory machine readable medium also includes instruction that when executed cause the at least one processor to process modality-specific embeddings of the received data and generate one or more hypergraphs based on hyperedges constructed using the modality-specific embeddings. The non-transitory machine readable medium further includes instruction that when executed cause the at least one processor to conduct an analytics process based on the one or more hypergraphs.

Any single one or any combination of the following features may be used with the above examples. The modality-specific embeddings may be processed by extracting one or more features from the received data using a modal-specific feature extraction process. The one or more hypergraphs may be generated by aggregating the hyperedges based on hypergraph type. Feature vectors of the one or more hypergraphs may be smoothed. Features of the one or more hypergraphs may be concatenated with an encoder output of the neural network. The data of the multiple modalities may include system-level data sources, agent-level data sources, or a combination thereof. The analytics process may include a node-based anomaly detection process, a graph-based anomaly detection process, or a combination thereof.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example multi-modal collaborative autonomous system in accordance with this disclosure;

FIG. 2 illustrates an example hypergraph model for a multi-modal collaborative autonomous system in accordance with this disclosure;

FIG. 3A illustrates an example spatial grid of a multi-modal collaborative autonomous system in accordance with this disclosure;

FIG. 3B illustrates example hypergraphs of a multi-modal collaborative autonomous system based on the spatial grid of FIG. 3A in accordance with this disclosure;

FIG. 4 illustrates another example hypergraph model for a multi-modal collaborative autonomous system in accordance with this disclosure;

FIG. 5 illustrates an example method for structured higher-order modeling for multi-modal collaborative autonomous systems according to this disclosure; and

FIG. 6 illustrates an example device for structured higher-order modeling for multi-modal collaborative autonomous systems in accordance with this disclosure.

### DETAILED DESCRIPTION

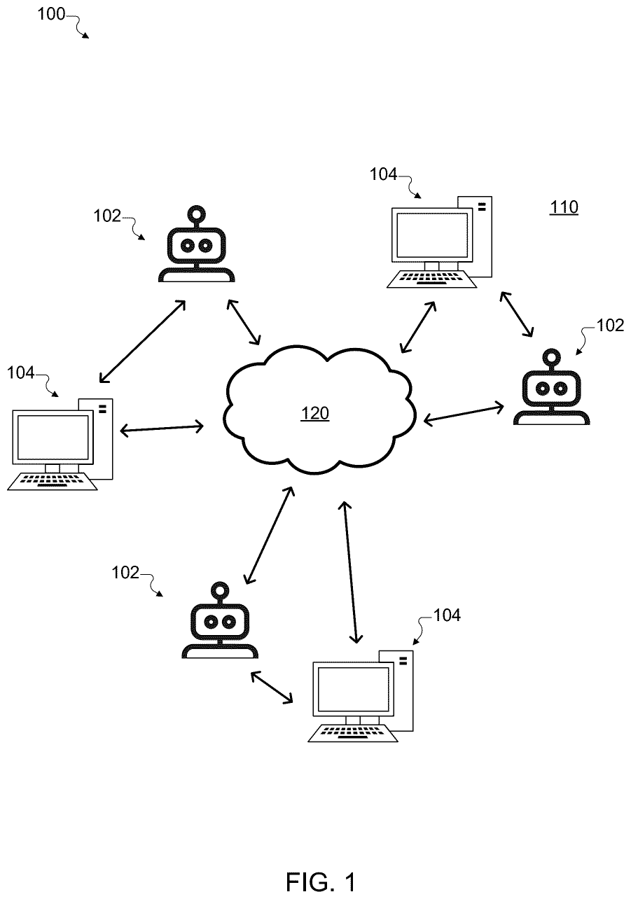

FIGS. 1 through 6, described below, and the various embodiments used to describe the principles of this disclosure are by way of illustration only and should not be construed in any way to limit the scope of this disclosure. Those skilled in the art will understand that the principles of this disclosure may be implemented in any type of suitably arranged device or system.

As discussed above, collaborative autonomous systems refer to networks of autonomous agents, such as robots, drones, or software systems, which work together to achieve shared goals. These systems rely on communication, coordination, and decision-making to perform tasks in dynamic environments. Pairwise communication is often used in collaborative autonomous systems, especially decentralized configurations, where two agents are in direct communication to exchange data. Among other uses, these correlated and coordinated behaviors and movements may be useful for pattern-of-life analytics. Unfortunately, these systems face challenges in effectively incorporating trajectory data (such as navigation traces or reporting) with multi-source data.

This disclosure provides systems and methods for structured higher-order modeling in multi-modal collaborative autonomous systems. For example, this disclosure provides a scalable graph analytics approach, such as one that can be used in learning nominal patterns of life in collaborative autonomous systems and detecting potential anomalous behaviors. Current methods use traditional graph structures that capture pairwise relationships, such as “robot A communicates/follows/trails robot B” or “operator D interacts with robot E”, but miss multi-dimensional and context-rich interactions useful for accurate pattern of life behavior modeling and anomaly detection. This disclosure provides for methods and systems using hypergraph-based models for analytics, allowing multiple entities (such as robots, hardware, operators, or other entities) to interact within a single hyperedge capturing more complete and more nuanced interactions. As a result, this provides a structured approach to model higher-order correlations within data, to improve understandings of nominal patterns of life, and to detect deviations indicative of potential anomalous behaviors.

FIG. 1 illustrates an example multi-modal collaborative autonomous system 100 in accordance with this disclosure. As shown in FIG. 1, the multi-modal collaborative autonomous system 100 includes multiple agents 102 coupled to multiple user devices 104 in an environment 110. Each of the multiple agents 102 may be coupled to each other or other multiple user devices 104 over a network 120. The multiple agents 102 perform various tasks in the environment 110 and each of the multiple agents 102 collect various forms of data, including trajectory data, video or sensor feeds, and telemetry data.

Although FIG. 1 illustrates one example of a multi-modal collaborative autonomous system 100, various changes may be made to FIG. 1. For example, various components in FIG. 1 may be combined, further subdivided, replicated, omitted, or rearranged and additional components may be added according to particular needs.

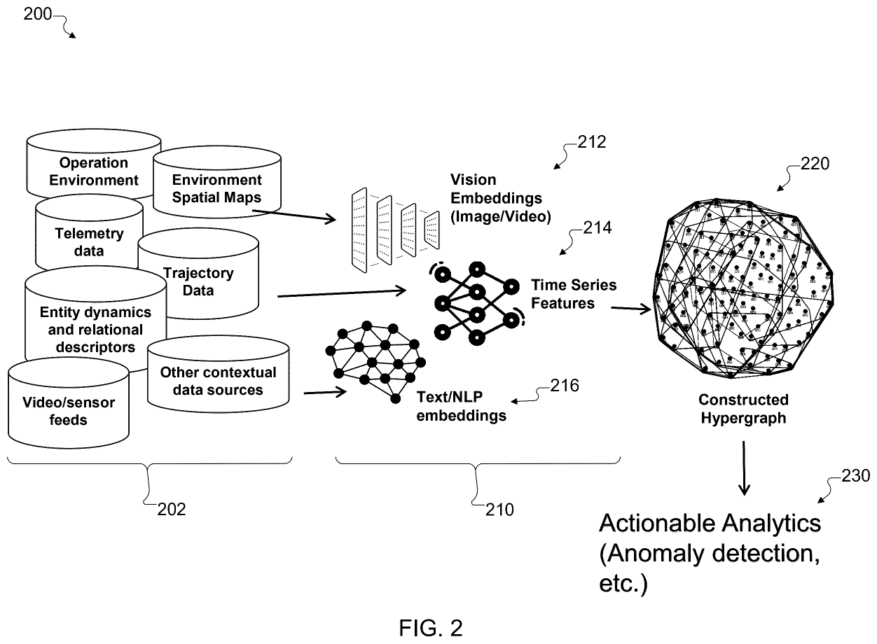

FIG. 2 illustrates an example hypergraph model 200 for a multi-modal collaborative autonomous system in accordance with this disclosure. As shown in FIG. 2, the hypergraph model 200 is based on information from one or more raw data sources 202 (such as from the multiple agents 102) and modality-specific features 210 extracted from the information. For example, the raw data sources 202 may include operational environment data, environment spatial maps, telemetry data, trajectory data, entity dynamics and relational descriptors, video or sensor feed data, and other contextual data sources. As such, the modality-specific features 210 may include vision embeddings 212, time series features 214, and text embeddings 216. Other features may be extracted based on the raw data sources 202 and feature extraction processes performed. The modality-specific features 210 are used to construct one or more hypergraphs 220 that are used for actionable analytics 230, such as anomaly detection.

The one or more hypergraphs 220 are generalizations of traditional graphs, where hyperedges in each hypergraph 220 may connect more than two vertices. In contrast, in a standard graph, an edge links only two vertices. Each hyperedge in the one or more hypergraphs 220 may include any number of vertices. The hyperedges in the one or more hypergraphs 220 are constructed to represent relationships or connections among multiple vertices extending beyond the pairwise connections of traditional graphs. Hyperedges can be formed based on shared attributes or features among the vertices and may change over time (such as in dynamic environments). This allows the one or more hypergraphs 220 to change over time, allowing for analysis of multi-dimensional and context-rich interactions, improving the accuracy of pattern of life behavior modeling and anomaly detection.

Although FIG. 2 illustrates one example of a hypergraph model 200 for a multi-modal collaborative autonomous system, various changes may be made to FIG. 2. For example, although only one hypergraph is shown, more may be used according to particular needs.

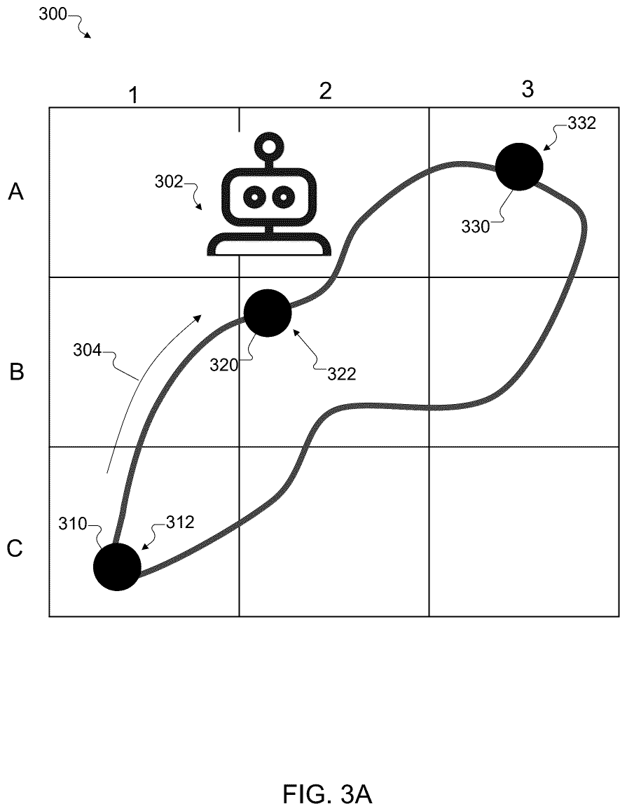

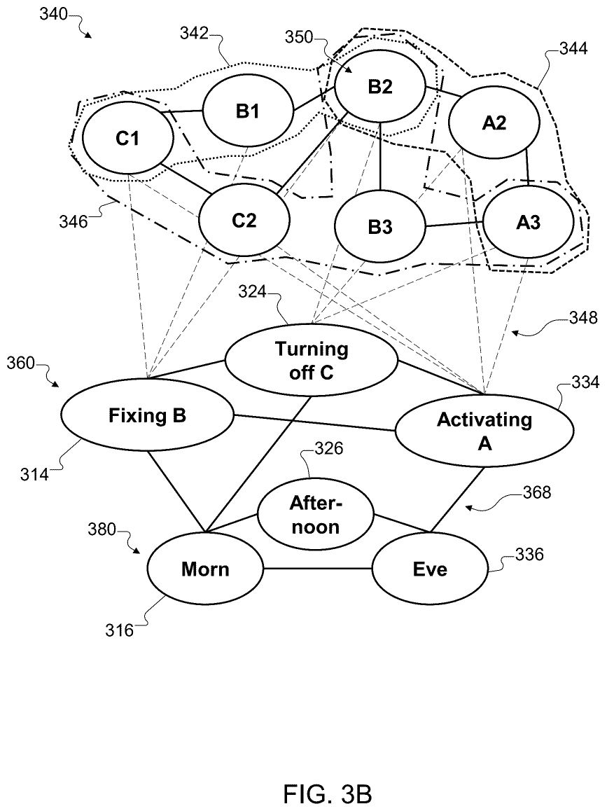

FIG. 3A illustrates an example spatial grid 300 of a multi-modal collaborative autonomous system in accordance with this disclosure. FIG. 3B illustrates example hypergraphs 340, 360, 380 of a multi-modal collaborative autonomous system based on the spatial grid 300 of FIG. 3A in accordance with this disclosure. As shown in FIG. 3A, the spatial grid 300 includes an agent 302 (such as one of the multiple agents 102) in the environment 110. The agent 302 may follow an agent path 304 between a first station 310 at a first grid location 312, a second station 320 at a second grid location 322, and a third station 330 at a third grid location 332. The agent 302 may perform a first task 314 during a first period 316 at the first station 310, a second task 324 during a second period 326 at the second station 320, and a third task 334 during a third period 336 at the third station 330. Through the agent path 304, the agent 302 is configured to collect and transmit data. For example, the agent 302 may report location data as well as time data and task assignments throughout the agent path 304 (such as at each of the first station 310, the second station 320, and the third station 330).

As shown in FIG. 3B, the data collected and reported by the agent 302 is used to construct a first hyper edge 342, a second hyper edge 344, and a third hyper edge 346. For example, the hyperedges may be constructed based on shared attributes or features among vertices. The vertices may be data points, such as the first grid location 312, the second grid location 322, the third grid location 332, or the first task 314, the second task 324, the third task 334, or different segments of the agent path 304. To do so, statistical or algorithmic techniques, such as clustering, may be used to group vertices into hyperedges based on similarity metrics. Construction of the hyperedges may also include domain-specific rules to guide hyperedge formation.

As an example, the first hyper edge 342 may include the spatial data or trajectory data between the first station 310 where the agent 302 performed the first task 314 and the second station 320 where the agent 302 performed the second task 324. In particular, the first hyper edge 342 may include multiple vertices 350 (such as grid positions) that the agent 302 crossed during this portion of the agent path 304 to reach the second station 320 (such as C1, B1, and B2). Similarly, the second hyper edge 344 may include the trajectory data between the second station 320 where the agent 302 performed the second task 324 and the third station 330 where the agent 302 performed the third task 334. As such, the second hyper edge 344 may include grid positions that the agent 302 crossed to reach the third station 330 from the second station 320 (such as B2, A2, and A3). Additionally, the third hyper edge 346 may include the trajectory data between the third station 330 where the agent 302 performed the third task 334 and the first station 310 where the agent 302 may enter a standby mode. As such, the second hyper edge 344 may include grid positions that the agent 302 crossed to reach the first station 310 from the third station 330 (such as A3, B3, B2, C2, and C1).

The first hyper edge 342, the second hyper edge 344, and the third hyper edge 346 may be used to generate a spatial hypergraph 340. For example, once the vertices and the hyperedges are defined, the spatial hypergraph 340 can be constructed by associating each hyperedge with its corresponding set of vertices, where the vertices represent a mode of a multi-modal data point. The spatial hypergraph 340 can be formed by first hyper edge 342, the second hyper edge 344, and the third hyper edge 346 using the vertices or nodes representing spatial data. Other hypergraphs may be similarly constructed (such as entity behavioral hypergraph based on entity behavior data or geographical proximity hypergraph based on geographical data), where each vertex or node includes each of the modes of the multi-mode data. As such, the spatial hypergraph 340 may provide contextual data based on the hyperedges, such as grid positions that are frequented by the agent 302 when executing tasks (such as B2), that may not otherwise be available in pairwise relationship analytics.

As each hyperedge can contain multi-modal data or multi-modal features, the first hyper edge 342, the second hyper edge 344, and the third hyper edge 346 may, using first intermodal connections 348, generate an intention hypergraph 360 and subsequently, using second intermodal connections 368, a time context hypergraph 380. The first intermodal connections 348 and the second intermodal connections 368 refer to relationships or interactions that link different hypergraphs (such as the spatial hypergraph 340 to the intention hypergraph 360 and the intention hypergraph 360 to the time context hypergraph 380, respectively) across different modalities. The first intermodal connections 348 and the second intermodal connections 368 identify shared vertices or hyperedges between hypergraphs to facilitate transfer of information.

As an example of this, the intention hypergraph 360 includes each of the first task 314, the second task 324, and the third task 334 shared with the grid locations of the spatial hypergraph 340. The time context hypergraph 380 includes each of the first period 316, the second period 326, and the third period 336 shared with the tasks of the intention hypergraph 360. The first intermodal connections 348 allow the intention hypergraph 360 and the time context hypergraph 380 to be contextually related to the spatial hypergraph 340. For example, the spatial hypergraph 340, the intention hypergraph 360, and the time context hypergraph 380 may be read together to determine the grid positions and the period that the agent 302 used to perform a task (such as the second task).

Although FIG. 3A illustrates one example of a spatial grid 300 of a multi-modal collaborative autonomous system 100 and FIG. 3B illustrates examples of hypergraphs 340, 360, 380 of a multi-modal collaborative autonomous system 100 based on the spatial grid 300 of FIG. 3A, various changes may be made to FIGS. 3A and 3B. For example, the specific spatial grid and hypergraphs shown here are examples only and can easily vary based on the specific circumstances.

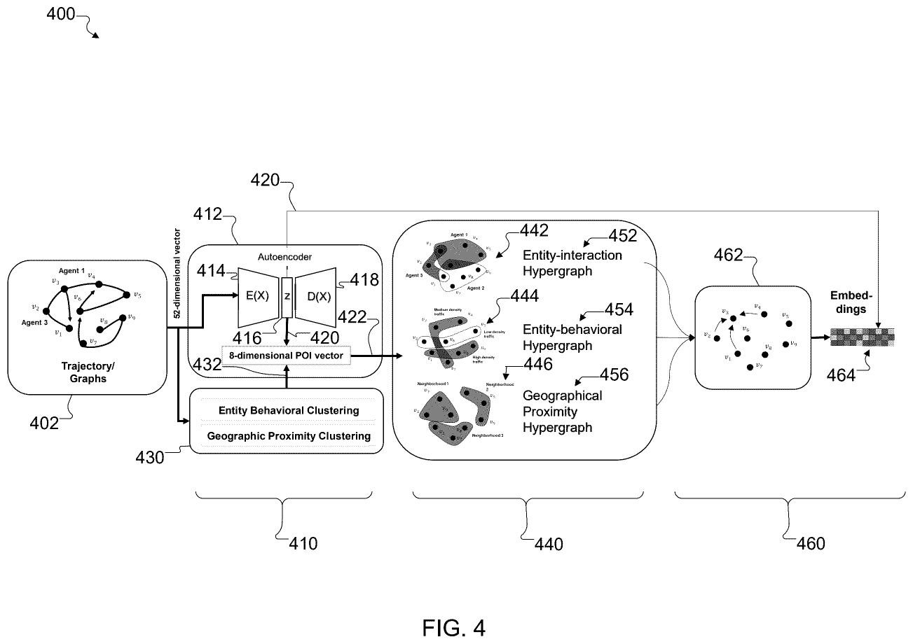

FIG. 4 illustrates another example hypergraph model 400 for a multi-modal collaborative autonomous system in accordance with this disclosure. As shown in FIG. 4, the hypergraph model 400 is based on available multi-mode data 402 (such as data obtained using one or more of the multiple agents 102). The available multi-mode data 402 may include, for example, trajectory data, task data, and time data from an agent path (such as the agent path 304). The available multi-mode data 402 is transmitted to an embedding and clustering function 410, which includes a neural network 412.

The neural network 412 may be configured as an autoencoder and can include an encoder 414, a latent space 416, and a decoder 418 that collectively generate an autoencoder output 420. The neural network 412 may be configured for dimensionality reduction. For example, the neural network 412 can be configured to extract features from the available multi-mode data 402 (which may be received as a vector of size N). The available multi-mode data 402 can be encoded and compressed to extract relevant features (such as point of interest features) using the encoder 414 to generate compressed or lower-dimensional data 404 in the latent space 416. For example, the point of interest features may include a spatial location that has been traversed and visited by any of the agents. The lower-dimensional data 404 may be clustered in the latent space 416 using any suitable clustering algorithm (such as k-means, density-based spatial clustering (DBSCAN), or hierarchical clustering) before decoding in the decoder 418 to produce the autoencoder output 420 (which may be a vector of size M, where M<N).

The embedding and clustering function 410 also includes a clustering function 430 configured to perform one or more clustering processes, such as entity behavioral clustering and/or geographic proximity clustering, to produce a clustering output 432. For example, the clustering function 410 may receive the available multi-mode data 402 and extract relevant features, such as statistical metrics, temporal patterns, and categorical attributes, and apply a clustering technique (such as k-means, Gaussian Mixture Models, or hierarchical clustering) to group entities with similar behaviors to perform entity behavioral clustering. Similarly, relevant geographical features may be extracted and clustered to perform geographic proximity clustering. As such, the clustering output 432 may include behavioral, geographic, or other embeddings. The clustering output 432 can represent a vector whose values represent the relationship of data points to the clusters used.

In some cases, the clustering output 432 may be combined with the autoencoder output 420 to generate an embedded output 422. For example, the clustering output 432 may be appended to the autoencoder output 420 to create the embedded output 422. The embedded output 422 can be transmitted to a hyperedge construction function 440.

The hyperedge construction function 440 may use the embedded output 422 to generate a first set of hyperedges 442, a second set of hyperedges 444, and a third set of hyperedges 446. For example, the hyperedge construction function 440 may use the embedded output 422 to determine relevant vertices to generate the first set of hyperedges 442 and create a first hypergraph 452 based on a first characteristic, the second set of hyperedges 444 and create a second hypergraph 454 based on a second characteristic, and the third set of hyperedges 446 and create a third hypergraph 456 based on a third characteristic. As particular examples, similarity or distance metrics may be used on the embedded output 422 (such as cosine similarity or Euclidean distance) to identify groups of vertices that share common characteristics, such as location or task, and grouped together to form the set of hyperedges. As the vertices change over time, so do each set of hyperedges, allowing the hypergraphs to adapt to new conditions or interactions. Other hypergraph and hyperedge types may be generated based on the embedded output 422.

The generated hypergraphs undergo smoothing and embedding in a hypergraph message passing function 460. For example, the hypergraph message passing function 460 may include a smoothing function 462 configured to smooth the feature vectors (such as the vertices or hyperedges) of a hypergraph. The smoothing function 462 may be configured to perform a smoothing process, such as Laplacian smoothing, on the generated hypergraphs. The hypergraph message passing function 460 may also include a concatenation function 464, which may be configured to concatenate features of the hypergraphs (such as the vertices) with the autoencoder output 420 of the neural network 412. This updates the hyperedges and therefore the hypergraphs for improved accuracy.

Although FIG. 4 illustrates another example of a hypergraph model 400 for a multi-modal collaborative autonomous system, various changes may be made to FIG. 4. For example, while the neural network 412 is configured here as an autoencoder, other types of neural networks may be used to reduce dimensionality of multi-modal data, such as principal component analysis (PCA) or U-Map embedding.

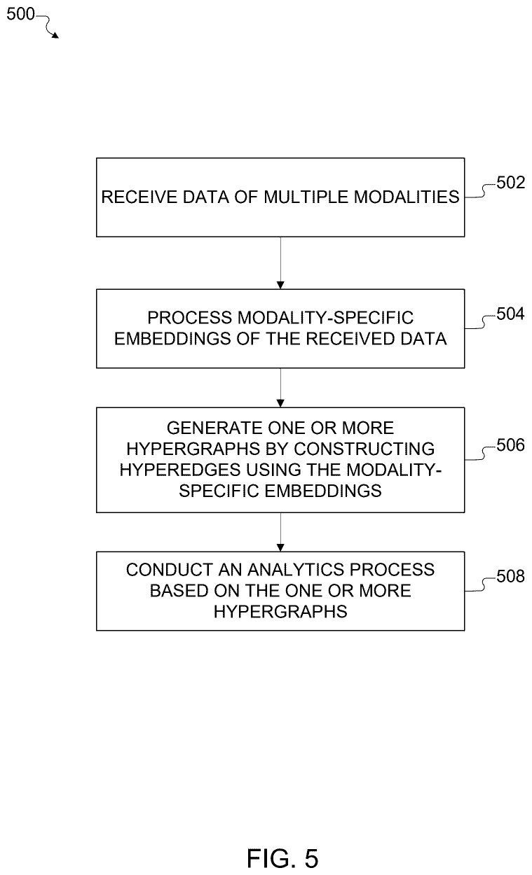

FIG. 5 illustrates an example method 500 for structured higher-order modeling for multi-modal collaborative autonomous systems according to this disclosure. For ease of explanation, the method 500 of FIG. 5 is described as being performed by a node within the multi-modal collaborative autonomous system 100 of FIG. 1 and the hypergraph model 400 of FIG. 4. However, the method 500 may be used with any other suitable device and in any other suitable hypergraph model (such as the hypergraph model 300 FIGS. 3A-3B).

As shown in FIG. 5, data of multiple modalities is received using at least one transceiver at step 502. For example, one of the multiple agents 102 may collect and transmit data using agent-level data sources, such as trajectory data, telemetry data, and video or sensor feed data. The multiple user devices 104 may receive the transmitted multi-modal data and combine it with system-level data sources (possibly from others of the multiple agents 102), such as spatial maps, textual logs, entity relational data, operating environment data, mission conditions or objectives, and other contextual data. Alternatively, the multiple agents 102 may collect and receive data of multiple modalities, including system-level data sources.

Modality-specific embeddings of the received data are processed at step 504. For example, the multiple user devices 104 may conduct modal-specific feature extraction for the received data, such as video feature extraction using a convolution neural network or natural language processing to extract text-based features. Similarly, the multiple agents 102 may perform agent-level processing to generate combined features of the agent-level data sources (such as trajectory features or telemetry features). Further, the multiple user devices 104 may perform embedding and clustering along with a neural network 412 to generate an autoencoder output 420 and an embedded output 422 based on the available multi-mode data 402.

One or more hypergraphs are generated based on hyperedges constructed using the modality-specific embeddings at step 506. For example, the multiple user devices 104 may use the extracted features to generate the first set of hyperedges 442, the second set of hyperedges 444, and the third set of hyperedges 446. The hyperedges may be constructed by generating a point of interest (POI) vector using the neural network 412. The first set of hyperedges 442, the second set of hyperedges 444, and the third set of hyperedges 446 can be used to generate the first hypergraph 452, for example, by aggregating the hyperedges based on hypergraph type. Using intermodal connections, the first set of hyperedges 442, the second set of hyperedges 444, and the third set of hyperedges 446 may be used to generate the second hypergraph 454. Similarly, the first set of hyperedges 442, the second set of hyperedges 444, and the third set of hyperedges 446 may be used to generate the third hypergraph 456 using another set of intermodal connections.

An analytics process is conducted based on the one or more hypergraphs at step 508. Once the one or more hypergraphs (such as the first hypergraph 452, the second hypergraph 454, and the third hypergraph 456) are generated, an analytics process may, for example, use the one or more hypergraphs to detect anomalies in the multi-modal collaborative autonomous system 100. For example, the anomaly detection process may include a node-based anomaly detection process, a graph-based anomaly detection process, or a combination thereof. The node-based anomaly detection process may include identification of unusual or abnormal nodes based on their relationship with the hypergraph within the one or more hypergraphs. This may include using distance-based methods where nodes farther from their neighbors in a hyperedge or other feature space are identified as potential anomalies. Additionally or alternatively, the node-based anomaly detection process may include density-based methods where nodes in lower-density regions of the hypergraph are identified as potential anomalies. The graph-based anomaly detection process may include detecting (i) edge-level anomalies where hyperedges with unexpected weights or connections are identified as potential anomalies or (ii) subgraph-level anomalies where portions or subgraphs of the hypergraph with irregular patterns or structures are identified as potential anomalies.

In some cases, the anomaly detection process may include scan statistics that analyze local regions of the one or more hypergraphs to detect areas of excessive activity or unusual connections. Additionally or alternatively, the anomaly detection process may incorporate a neural network configured to detect anomalies, for example, based on forecast errors or deviations from expected patterns in the one or more hypergraphs. Additionally or alternatively, the anomaly detection process may include density-based methods where sparse regions or regions of the one or more hypergraphs with a density below a predetermined threshold are identified as potential anomalies. In addition to an anomaly detection process, the analytics process may include other data analytics processes, such as supervised tasks like classification processes or regression processes.

Although FIG. 5 illustrates one example of a method 500 for structured higher-order modeling for multi-modal collaborative autonomous systems, various changes may be made to FIG. 5. For example, while shown as a series of steps, various steps in FIG. 5 may overlap, occur in parallel, or occur any number of times (including zero times).

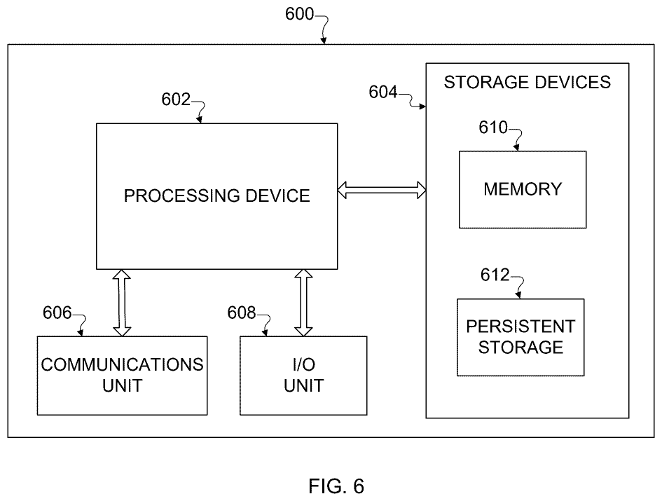

FIG. 6 illustrates an example device for structured higher-order modeling for multi-modal collaborative autonomous systems in accordance with this disclosure.

FIG. 6 illustrates an example device 600 configured for structured higher-order modeling for multi-modal collaborative autonomous systems according to this disclosure. One or more instances of the device 600 (or portions thereof) may, for example, be used to, at least partially, implement the functionality of each node in the multi-modal collaborative autonomous system 100 of FIG. 1. However, the functionality of each node in the multi-modal collaborative autonomous system 100 may be implemented in any other suitable manner.

As shown in FIG. 6, the device 600 denotes a computing device or system that includes at least one processing device 602, at least one storage device 604, at least one communications unit 606, and at least one input/output (I/O) unit 608. The processing device 602 may execute instructions that can be loaded into a memory 610. The processing device 602 includes any suitable number(s) and type(s) of processors or other devices in any suitable arrangement. Example types of processing devices 602 include one or more microprocessors, microcontrollers, digital signal processors (DSPs), application-specific integrated circuits (ASICs), graphics processing units (GPUs), field-programmable gate arrays (FPGAs), or discrete circuitry.

The memory 610 and a persistent storage 612 are examples of storage devices 604, which represent any structure(s) capable of storing and facilitating retrieval of information (such as data, program code, and/or other suitable information on a temporary or permanent basis). The memory 610 may represent a random access memory or any other suitable volatile or non-volatile storage device(s). The persistent storage 612 may contain one or more components or devices supporting longer-term storage of data, such as a read only memory, hard drive, Flash memory, or optical disc.

The communications unit 606 supports communications with other systems or devices. For example, the communications unit 606 can include a network interface card or a wireless transceiver facilitating communications over a wired or wireless network. The communications unit 606 may support communications through any suitable physical or wireless communication link(s).

The I/O unit 608 allows for input and output of data. For example, the I/O unit 608 may provide a connection for user input through a keyboard, mouse, keypad, touchscreen, or other suitable input device. The I/O unit 608 may also send output to a display or other suitable output device. Note, however, that the I/O unit 608 may be omitted if the device 600 does not require local I/O, such as when the device 600 can be accessed remotely or operated autonomously.

In some embodiments, the instructions executed by the processing device 602 can include instructions that implement all or portions of the functionality of the multi-modal collaborative autonomous system 100 described above. For example, the instructions executed by the processing device 602 can include instructions for structured higher-order modeling for multi-modal collaborative autonomous systems as described above.

Although FIG. 6 illustrates one example of a device 600 for structured higher-order modeling for multi-modal collaborative autonomous systems, various changes may be made to FIG. 6. For example, computing devices and systems come in a wide variety of configurations, and FIG. 6 does not limit this disclosure to any particular computing device or system.

It should be noted that the functions shown in or described with respect to FIGS. 1 through 6 can be implemented in a server or other electronic device(s) in any suitable manner. For example, in some embodiments, at least some of the functions shown in or described with respect to FIGS. 1 through 6 can be implemented or supported using one or more software applications or other software instructions that are executed by the processing device(s) 602 of a server or other electronic device(s). In other embodiments, at least some of the functions shown in or described with respect to FIGS. 1 through 6 can be implemented or supported using dedicated hardware components. In general, the functions shown in or described with respect to FIGS. 1 through 6 can be performed using any suitable hardware or any suitable combination of hardware and software/firmware instructions. Also, the functions shown in or described with respect to FIGS. 1 through 6 can be performed by a single electronic device or by multiple electronic devices.

In some embodiments, various functions described in this patent document are implemented or supported by a computer program or other program that is formed from computer readable program code or instructions and that is embodied in a computer or machine readable medium. The phrases “computer readable program code” and “instructions” include any type of code, including source code, object code, and executable code. The phrases “computer readable medium” and “machine readable medium” include any type of medium capable of being accessed by a computer or other machine, such as read only memory (ROM), random access memory (RAM), a hard disk drive (HDD), a compact disc (CD), a digital video disc (DVD), or any other type of memory. A “non-transitory” computer or machine readable medium excludes wired, wireless, optical, or other communication links that transport transitory electrical or other signals. A non-transitory computer or machine readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving data of multiple modalities using at least one transceiver of a node in a multi-modal collaborative autonomous system;
processing modality-specific embeddings of the received data;
generating one or more hypergraphs based on hyperedges constructed using the modality-specific embeddings; and
conducting an analytics process based on the one or more hypergraphs.

2. The method of claim 1, wherein processing modality-specific embeddings comprises extracting one or more features from the received data using a modal-specific feature extraction process.

3. The method of claim 1, wherein generating the one or more hypergraphs comprises:
generating the one or more hypergraphs by aggregating the hyperedges based on hypergraph type.

4. The method of claim 3, further comprising:
smoothing feature vectors of the one or more hypergraphs.

5. The method of claim 3, further comprising:
concatenating features of the one or more hypergraphs with an encoder output of the neural network.

6. The method of claim 1, wherein the data of the multiple modalities comprises system-level data sources, agent-level data sources, or a combination thereof.

7. The method of claim 1, wherein the analytics process comprises a node-based anomaly detection process, a graph-based anomaly detection process, or a combination thereof.

8. An apparatus comprising:
at least one transceiver; and
at least one processing device configured to:
receive data of multiple modalities using the at least one transceiver, the data associated with a multi-modal collaborative autonomous system;
process modality-specific embeddings of the received data;
generate one or more hypergraphs based on hyperedges constructed using the modality-specific embeddings; and
conduct an analytics process based on the one or more hypergraphs.

9. The apparatus of claim 8, wherein, to process the modality-specific embeddings, the at least one processing device is configured to extract one or more features from the received data using a modal-specific feature extraction process.

10. The apparatus of claim 8, wherein, to generate the one or more hypergraphs, the at least one processing device is configured to:
construct the hyperedges by generating a point of interest (POI) vector using a neural network; and
generate the one or more hypergraphs by aggregating the hyperedges based on hypergraph type.

11. The apparatus of claim 10, wherein the at least one processing device is further configured to smooth feature vectors of the one or more hypergraphs.

12. The apparatus of claim 10, wherein the at least one processing device is further configured to concatenate features of the one or more hypergraphs with an encoder output of the neural network.

13. The apparatus of claim 8, wherein the data of the multiple modalities comprises system-level data sources, agent-level data sources, or a combination thereof.

14. The apparatus of claim 8, wherein the analytics process comprises a node-based anomaly detection process, a graph-based anomaly detection process, or a combination thereof.

15. A non-transitory machine readable medium comprising instructions that when executed cause at least one processor of a node in a multi-modal collaborative autonomous system to:
receive data of multiple modalities using at least one transceiver;
process modality-specific embeddings of the received data;
generate one or more hypergraphs based on hyperedges constructed using the modality-specific embeddings; and
conduct an analytics process based on the one or more hypergraphs.

16. The non-transitory machine readable medium of claim 15, wherein the instructions that when executed cause the at least one processor to process the modality-specific embeddings comprise:
instructions that when executed cause the at least one processor to extract one or more features from the received data using a modal-specific feature extraction process.

17. The non-transitory machine readable medium of claim 15, wherein the instructions that when executed cause the at least one processor to generate the one or more hypergraphs comprise:
instructions that when executed cause the at least one processor to:
construct the hyperedges by generating a point of interest (POI) vector using a neural network; and
generate the one or more hypergraphs by aggregating the hyperedges based on hypergraph type.

18. The non-transitory machine readable medium of claim 17, further containing instructions that when executed cause the at least one processor to smooth feature vectors of the one or more hypergraphs.

19. The non-transitory machine readable medium of claim 17, further containing instructions that when executed cause the at least one processor to concatenate features of the one or more hypergraphs with an encoder output of the neural network.

20. The non-transitory machine readable medium of claim 15, wherein the data of the multiple modalities comprises system-level data sources, agent-level data sources, or a combination thereof.
